(19) United States
(12) Patent Application Publication
(10) Pub. No.: US 2010/0196850 A1
(43) Pub. Date: Aug. 5, 2010

(54) DENTAL IMPLANT

(75) Inventor: Arno König, Thalwil (CH)

Correspondence Address: SPECKMAN LAW GROUP PLLC, 1201 THIRD AVENUE, SUITE 330, SEATTLE, WA, 98101, US

(73) Assignee: DENTALPOINT AG, Zurich (CH)

(21) Appl. No.: 12/669,456

(22) PCT Filed: Jul. 16, 2007
(86) PCT No.: PCT/CH07/00343

§ 371 Date: Jan. 15, 2010

(51) Int. Cl. A61C 8/00

(52) U.S. Cl. 433/173

(57) ABSTRACT

A tooth replacement system (1, 2, 3, 4, 5) is proposed that comprises an implant (10, 20, 30, 31, 32), for osseointegration in a jaw bone, and an abutment (40, 50, 60, 70, 80), wherein the abutment can be positioned in at least two radial angle positions by the form-fit interaction of locking means, on a proximal abutment base, and of at least one inner wall of the proximal portion of the receiving opening (11). The locking means preferably comprise an N-edge wrench socket (13, 13a) in the implant and an N*X external polygon (44) on the abutment, where N designates the number of locking surfaces (45) in the wrench socket and N*X stands for an integral multiple of N. The pairs of locking means are advantageously based on regular polygons, in each case preferably selected from the three, four, five or six series. The possibilities of simple production afford complete freedom in terms of the choice of material, such that the implants and also the abutments can be made from titanium or ceramic, and both structural parts can be used in all possible material combinations.

The present invention relates to a tooth replacement system according to the preamble of Claim 1.

### FIELD OF THE INVENTION

For many years, a wide variety of tooth replacement systems have been offered on the market under the terms tooth implant or dental implant, and some of them have been used with great success. The terms tooth implant or dental implant generally stand for the tooth replacement per se and should not be confused with the actual implant body which, as tooth root replacement, is correctly designated as implant. In the text that follows, the terms tooth implant and implant body or implant are clearly distinguished, with the tooth implant designating the tooth replacement, which comprises the implant body for anchoring in the jaw bone. Two-part and three-part tooth implants predominate on the market, and the three-part tooth implants for replacement of an individual tooth generally consist of an endosseous implant or implant body, an abutment (also called connection part or implant post), and a crown, a bridge or another prosthesis. The abutment allows the dentist to orient the crown in relation to the implant, such that the exact position of the crown in the dental arch is not solely dependent on the setting of the implant body. The setting and the position of the implant is often determined by the particular anatomical situation in the patient's jaw. The setting of the crown can be corrected by means of suitably shaped or adjustable abutments or by working the abutment after insertion.

The choice of materials for the implant is greatly limited by stringent requirements in respect of biocompatibility and of the mechanical properties of the implant. In the last few decades, titanium in particular has become the preferred material, because it has a modulus of elasticity similar to the jaw bone and has excellent biocompatibility.

However, a disadvantage of the implants and abutments made of titanium lies in their dark colour. In the event of the gum and bone receding, the dark metal parts may become visible or show through especially in the area of the front teeth, which is extremely undesirable for cosmetic reasons. In recent years, therefore, ceramics, e.g. zirconium oxide ceramic, have attracted increasing interest as an alternative material. Critics argue that the high modulus of elasticity of implants made from zirconium oxide ceramic leads to deep-seated fractures of the implant bodies and that their lesser degree of osseointegration compared to titanium may lead to extensive inflammation that breaks up the bone. Tooth implants made from titanium are in turn thought to trigger negative reactions through metal intoxication.

Customary implant shapes include blade, needle, screw, cylinder and cone implants, which are each used for different indications. These indications are defined by the amount of available bone, the quality of the bone and the functional goal. In principle, it is possible to use subperiosteal and endosseous implants, although in practice it is almost exclusively endosseous implants that are used at present, of the types with blade systems, screw systems or cylinder systems. Commonly used endosseous implants have a substantially cylindrical structure and are screwed or hammered into a bore in the jaw bone or directly into the jaw bone. At the coronal end, the implants are provided with an open blind bore for receiving the abutment. Since the abutment for receiving the crown or a bridge protrudes through the gum into the oral cavity and is not fully enclosed by the gum, such tooth implants are referred to as semi-open. In the semi-open implants, the crown, which is in most cases made from conventional dental ceramic and/or metal, is adhesively bonded or cemented onto the abutment or the one-piece implant/abutment structure or is secured thereon by mechanical means. In the case of closed subgingival systems, by contrast, the implant is embedded as far as the level of the alveolar crest, and the mucoperiosteal cover is sewn over the implant. Once the implant has become incorporated, a second operation is needed to be able to apply the abutment and the desired bridge, crown or other prosthesis thereon.

WO 2006/084346 A1 from Medin Tech discloses an implant system with an abutment made of a non-metallic material, which system comprises an implant and a prosthesis support, which in turn comprises an abutment and a collar element. Important features of the implant system are that the parts of the implant system are pushed linearly into one another and adhesively bonded to one another. Between a substantially cylindrical base post and a head part, the abutment has a cylindrical neck part with a lower projection which is designed as a hexagon and serves for the radial positioning of the abutment in a corresponding recess in the shoulder of the implant. Triangular, pentagonal or heptagonal projections are described as being preferred and interact with corresponding triangular, pentagonal or heptagonal recesses in the implant shoulder and permit positioning of the abutment in three, five or seven different radial angle positions about the longitudinal axis of the implant. The central bore in the implant for receiving the base post is provided with an inner thread, which allows a screw cap or a spacer to be screwed in during the healing process. After the healing process, a collar element is pushed over the neck area of the abutment, and the base post is adhesively bonded into the threaded bore of the implant. The collar element arranged between implant and abutment must take up a considerable share of the mastication forces and, with its convex outer face, represents the surface of contact with respect to the surrounding gum. A central and continuous axial channel is arranged in the abutment to allow the adhesive to flow off. WO 2006/084346 A1 lists a whole series of ceramic and composite materials that are suitable for production of the abutment. A disadvantage of this system lies in the considerable technical effort involved in producing the central axial channel in the abutment and also in the mechanical loads and stresses to which the abutment is thereby exposed. The abutment, or the positioning element of the abutment, must therefore either be made of a material that withstands high mechanical stresses or, as has been mentioned above, must be suitably dimensioned. A further disadvantage is that the implant cannot be produced from ceramic material, with the result that a purely ceramic system composed of ceramic implant and ceramic abutment cannot be achieved according to the invention in WO 2006/084346 A1.

EP 1728486 from Straumann discloses an implant system with an implant and an abutment, in which the abutment is provided with means for rotationally locked mounting of the abutment in the implant. A receiving opening in the implant is designed in such a way that a base portion of the abutment can be inserted substantially with a form fit and at the desired angle position into the receiving opening of the implant and is secured in this position on the implant by a separate screw. To receive the screw, the abutment is provided with a central continuous bore, such that the base area has to be designed with a very thin wall. The means that prevent twisting of the abutment and implant relative to each other consist in turn of a polygonal anti-rotation element on the abutment and of a recess that has a shape corresponding to the anti-rotation element. The system in EP 1728486 A1 does not allow the implant and abutment to be produced from ceramic at reasonable cost using known production methods and techniques.

EP 1763324 discloses a multi-part implant system in which an angled abutment is in turn secured on the implant body by means of a separate screw. When the implant is being screwed in, the necessary torque is transmitted with a Torx®-like wrench socket in the form of a hex socket. In the same way as in the Torx® inner profile, the drive area arranged at the distal end of the receiving opening of the implant has a profile with perpendicular drive surfaces, which profile, on the one hand, prevents the occurrence of reverse shearing forces and, on the other hand, ensures a good transmission of force by virtue of the relatively large drive surfaces. Corresponding to the inner profile in the implant, which inner profile resembles a six-pointed star with rounded tips and corners, the proximal end area of the abutment has an exactly matching outer undulating shape, likewise with six rounded tips and rounded corners, for insertion into the receiving opening of the implant. The abutment can be positioned in the implant in six discrete radial angle positions. The production of a close fit with such a complex geometry is complicated and expensive and is not really suitable for ceramic materials.

Despite the large number of known systems for replacing individual teeth, for treating large gaps between the teeth and shortened rows of teeth and for securing bridges or prostheses, there is an increasing need among users for products that avoid the disadvantages of the known systems.

### BACKGROUND OF THE INVENTION

It is an object of the invention to make available a generic tooth replacement system that does not have the abovementioned disadvantages. A further object is to make available a tooth replacement system comprising an implant and an abutment, which system, on the one hand, has an optimized geometry for transmitting the torque when the implant is being screwed in and, on the other hand, ensures the greatest possible variability of the stable angled positioning of the abutment. In addition, the tooth replacement systems according to the invention are intended to permit complete freedom of choice of material in the production and combination of abutments and implants made of metal and/or ceramic. They are to be simple and inexpensive to produce, and the tooth replacement system is intended to meet the very highest demands in respect of stability, quality and useful life.

This object is achieved by a tooth replacement system with the features of Claim 1.

An important advantage of the present invention is that the latter can be implemented in a wide variety of tooth replacement systems in which the abutment is to be positioned and rotationally locked in the implant at a defined angle position, in order thereafter, or after subsequent working of the abutment, to be able to secure a crown, bridge or other prosthesis in a predefined position on the abutment. In the text below, the word crown, unless expressly stated otherwise, is also intended to mean bridges and all other forms of prostheses that are mounted on the abutments.

In the tooth replacement systems according to the invention, the torque needed to screw in the implant is transmitted using a polygonal wrench socket with perpendicular drive surfaces. The polygonal wrench socket is preferably a triangle of uniform cross section which is arranged in a drive area at the proximal end of the receiving opening of the implant. The screwing-in tool is provided with a matching external polygon in order to obtain a polygonal wrench socket with a torque lock having the greatest possible drive surface. When the implant is being screwed into the bone, the profile with perpendicular drive surfaces prevents the occurrence of reverse shearing forces.

When inserted in the implant, the abutment can be positioned and locked in a plurality of discrete radial angle positions. An external polygon with perpendicular locking surfaces at the proximal end of the abutment engages in the polygonal wrench socket at the proximal end of the receiving opening of the implant. In contrast to the known implant systems, the polygonal wrench socket in the implant and the external polygon on the abutment do not have the same number of surfaces. An N-edge wrench socket in the implant is assigned an abutment with an N*X external polygon, where N designates the number of locking surfaces in the wrench socket and N*X stands for an integral multiple of N. For example, a triangular wrench socket is assigned an abutment with an external hexagon. Such an embodiment of the invention allows the abutment to be positioned and rotationally locked in the implant in six discrete angle positions, in which case the wrench socket, which is difficult to machine because of its location in the inside of the implant, is an easy-to-produce internal triangle. If an abutment is provided with an external nonagon, it is then possible, using the same implant with a triangular wrench socket, to fit and lock the abutment in nine predefined radial positions. An abutment with twelve external edges, when used with the same implant with the triangular wrench socket, permits twelve locking positions. The simple configuration of the wrench socket in the implant affords considerable advantages, especially in the case of ceramic implants, which are difficult to machine. The production of external polygons with six, nine or more locking surfaces is also economically viable in the case of ceramic abutments, since the area to be machined is freely accessible and, for example, can simply be ground.

Another decisive advantage of the system according to the invention lies in the fact that the dentist is able to select the number of locking positions simply by the choice of abutment. Since he is able to use several different types of abutments with the same implant, this considerably reduces the required storage volume.

In light of what has been explained above, a person skilled in the art will appreciate that the tooth replacement system according to the invention can also be used with pairs of locking means based on regular polygons, for example of the four, five or six series. For example, an implant with a four-sided socket, i.e. a substantially square socket, can be assigned abutments having an external polygon with eight, twelve or sixteen edges. In the case of an implant with a pentagonal socket, it is accordingly possible to use abutments having an external polygon with ten or fifteen edges and, in the case of implants with a hexagonal socket, to use abutments having an external polygon with twelve of sixteen edges. If systems with even more locking positions are desired, these too can be produced according to the invention without any problem.

According to a further embodiment of the invention, not all locking surfaces are physically embodied in the abutments to be inserted, and instead only a minimum required number of locking surfaces is formed. FIG. 6 shows schematically how in an abutment, which has a substantially circular cross section in the area of the locking means, three locking surfaces arranged tangentially with respect to the cylindrical jacket surface form a two-edge structure. This two-edge structure, with its three locking surfaces, corresponds functionally to a regular hexagon and permits the rotationally locked insertion of the abutment in six predefined angle positions. It is already clear from this example that the term polygon, as used below, includes not just “genuine polygons” in the form of polygonal prisms with regular polygonal cross-sectional surfaces and uniform side widths, but also “functional polygons” in which irregular polygonal prisms have sufficient areas of the genuine polygon to be able to serve as means with the same action.

All the preferred embodiments of the tooth replacement systems according to the invention have in common the fact that the form-fit interaction of locking means on abutment and implant ensures a reliable positioning of the abutment in a desired radial position (selected from a plurality of predefined discrete angle positions), with subsequent blocking in exactly this radial position. The torque-positive connection is preferably embodied as an inner socket in the area of the proximal abutment base and of at least one inner wall of a proximal portion of the receiving opening in the implant. It ensures that the implant according to preferred embodiments can be positioned in at least twice as many discrete radial angle positions as the inner socket has edges or locking surfaces.

The relatively simple geometry of the means involved in the positioning and locking makes it easier to maintain the required tolerances in the production of abutment and implant, particularly in the case of products made from ceramic.

In the tooth replacement systems according to the invention, the abutment is preferably adhesively bonded in the receiving opening, such that neither the abutment nor the implant has to be weakened by central bores for receiving a fastening screw.

Another advantage of the present invention is that it can be implemented not only in conventional implants, but also in implants that are constructed in accordance with the concept of platform switching. In the latter, preservation of the crestal bone is attempted by targeted combination of a smaller abutment diameter and a greater implant platform.

### BRIEF DESCRIPTION OF THE FIGURES

The invention is explained below with reference to the figures, which merely depict illustrative embodiments and in which:

FIG. 1 shows an implant of a tooth replacement system according to a first embodiment of the invention in a sectorial longitudinal section along the central axis, with an abutment inserted and with the crown not depicted;

FIG. 2a shows a side view of an abutment according to FIG. 1, which abutment has been turned 60° clockwise relative to the view in FIG. 1;

FIG. 2b shows the abutment according to FIG. 2a in an oblique view from the proximal direction;

FIG. 3 shows the implant according to FIG. 1 in a view from the distal direction into the receiving opening;

FIG. 4 shows schematic views of sections through an abutment (a) and an implant (b) according to a first embodiment in the area of the pair of locking means, individually (a, b) and in differently assembled states (c) to (h);

FIGS. 5 to 8 show schematic views of sections through in each case an abutment (a) and an implant (b) according to further embodiments in the area of the pairs of locking means, individually (a, b) and in the assembled state (c) or assembled states (c) and (d), and

FIG. 9 shows a further abutment in an oblique view from the proximal direction.

### DETAILED DESCRIPTION OF PREFERRED EMBODIMENTS

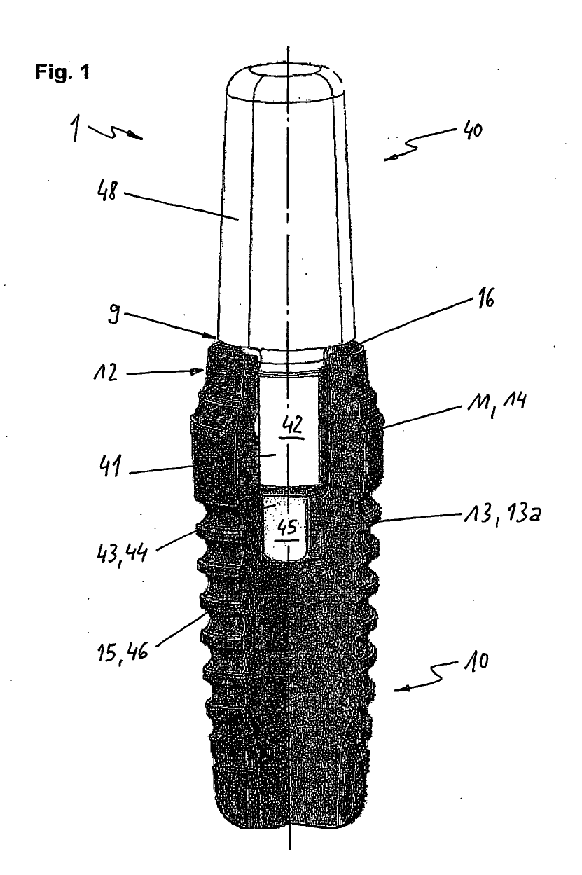

FIG. 1 shows a tooth replacement system 1 in the assembled state with a partially sectioned implant 10, so as to provide a free view of an abutment 40 with a cylindrical abutment stem 41 that is fitted in a corresponding cylindrical receiving opening 11 in the implant 10. The abutment stem 41 has a cylindrical outer jacket surface 42, which is produced with a shape exactly matching the cylindrical receiving opening 11. The abutment stem 41 narrows in a proximal area 43 and, in the illustrative embodiment depicted, merges into an external hexagon 44. The external hexagon 44 functions as a positioning aid when fitting the abutment into the implant 10 and as a locking means for securing the abutment 40 against twisting or blocking it against rotation when fitted in the implant 10.

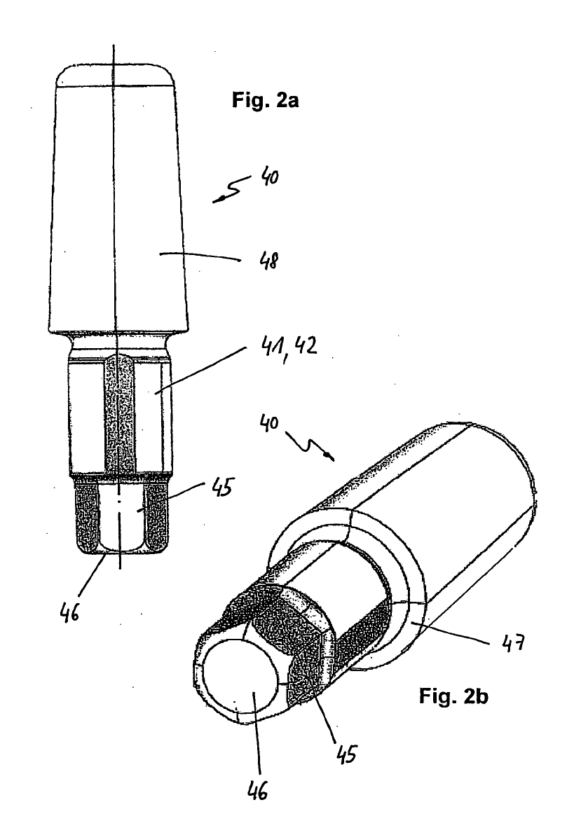

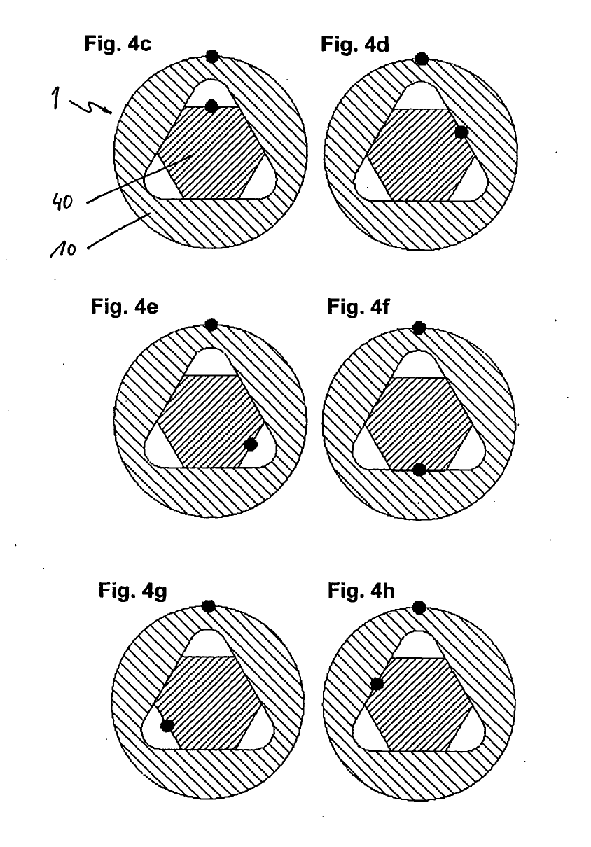

As will be seen from FIGS. 4c to 4h, the abutment 40 in this illustrative embodiment can be positioned and locked in six discrete radial angle positions. The external polygon 44 arranged at the proximal end of the abutment, and shown in FIGS. 2a and 2b, engages with its perpendicular locking surfaces 45 into a triangular wrench socket 13 at the proximal end of the receiving opening 11 of the implant 10. As has already been mentioned, in the novel systems according to the present invention, and in contrast to all known implant systems, the polygonal wrench socket 13 in the implant 10 and the external polygon 44 on the abutment 40 do not have the same number of surfaces.

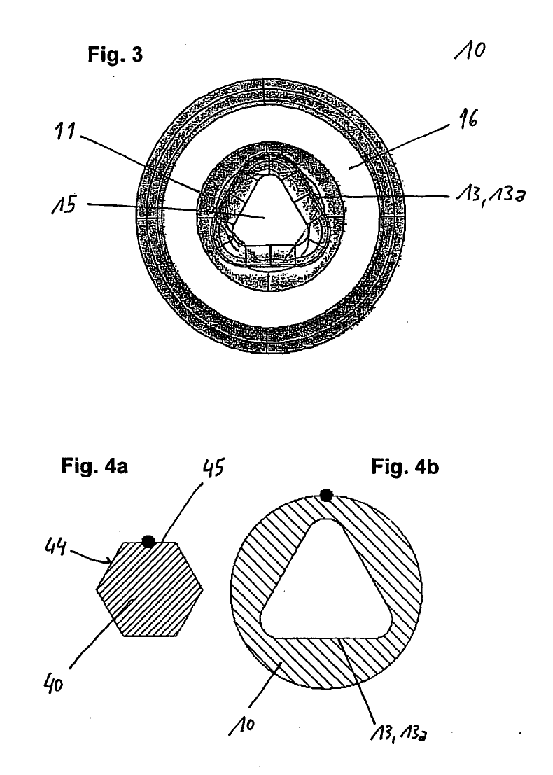

FIG. 3 shows the implant 10 from the distal direction. It provides a view into the substantially circular cylindrical blind bore extending from the coronal end 12 of the implant to the bottom of the receiving opening, which opens out coaxially at the lower end in the internal triangle 13.

The combination of locking means in the form of an external hexagon and an internal triangle is again illustrated schematically in FIGS. 4a to 4c. In the assembled state shown in FIG. 4c, the corresponding external hexagon 44 of the abutment 40 engages in the internal triangle 13 and acts as a means of securing against twisting. It will be clearly seen that the external hexagon 44 and the triangular wrench socket 13 are dimensioned such that the abutment 40, once fitted, can no longer be turned relative to the implant 10 about the central axis. FIG. 4c accordingly shows a first angle position of the abutment by means of a dot at the 12 o'clock position. FIGS. 4d to 4h show that the same abutment 40 can be positioned in five further discrete angle positions, each turned through 60°, in the implant 10, which is identified by a further dot as being fixed in position.

The abutment 40 is preferably adhesively bonded into the implant 10, such that a force-fit and form-fit connection is produced between the circular cylindrical area 42 of the abutment 40 and the corresponding circular cylindrical close-fit seat 14 of the receiving opening 11 in the implant 10. The cylindrical implant/abutment connection, which is very advantageously able to take up shearing forces, is supplemented by a proximal base surface 46 of the abutment stem 41 bearing with a force fit on the bottom 15 of the internal triangle 13 and thus of the receiving opening 11, which limits the axial movement of the abutment 40 in the proximal direction. In the assembled state, the axial forces acting on the abutment 40 are primarily introduced into the implant 10 via this bearing.

It will be evident to a person skilled in the art that the inventive locking means for positioning and blocking against rotation can advantageously also be used in implants with a conical abutment stem or with another shape of abutment stem.

The coronal end 12 of the abutment 10 is formed by an annular surface 16 that extends approximately perpendicular to the central axis and that surrounds the receiving opening 11. When the abutment 40 is inserted, an annular gap 9 is formed between this annular surface 16 and a proximal flange 47 in the transition area between the abutment stem 41 and the head area 48 of the abutment 40. This prevents the head 48 of the abutment 40 from coming to lie on the upper annular surface 16 of the implant 10 and ensures that, in the assembled state, force is introduced from the abutment 40 into the implant 10 only by way of the close-fit cylinder 42 in the stem area 41 and the base surface 46. In all embodiments, the distance created by the annular gap between abutment and implant is preferably between 5 and 15 μm, particularly preferably 10 μm, and it should not exceed 30 μm. By the adhesive bonding of implant 10 and abutment 40, the torsionally acting forces are also primarily taken up by the cylindrical close-fit seat, although they can also be transmitted by the torque-positive connection between the polygons and taken up by these.

The axial dimensions of the interacting portions 44 and 13 of the abutment 40 and of the implant 10 are adapted to each other in such a way that, with the abutment 40 inserted fully into the implant 10, the close-fit cylinder 42 of the abutment stem 41 is safely offset in its proximal end area relative to the internal triangle 13 and there is no undesired contact and loading here with axial force components. As is clear from FIG. 1, the height Hv of the external polygon or external hexagon 44 on the abutment 40 is greater than the depth of the corresponding internal triangle 13 in the implant 10.

The height Hv of the external polygon is preferably at least 1 mm, preferably between 1.5 and 6 mm, particularly preferably 1.5 mm. The edges of internal polygon and external polygon are preferably rounded with radii of at least 0.1 mm, preferably of between 0.2 and 0.3 mm, particularly preferably of 0.25 mm, in order to facilitate the insertion of the abutment and to avoid peak loads on the ceramics.

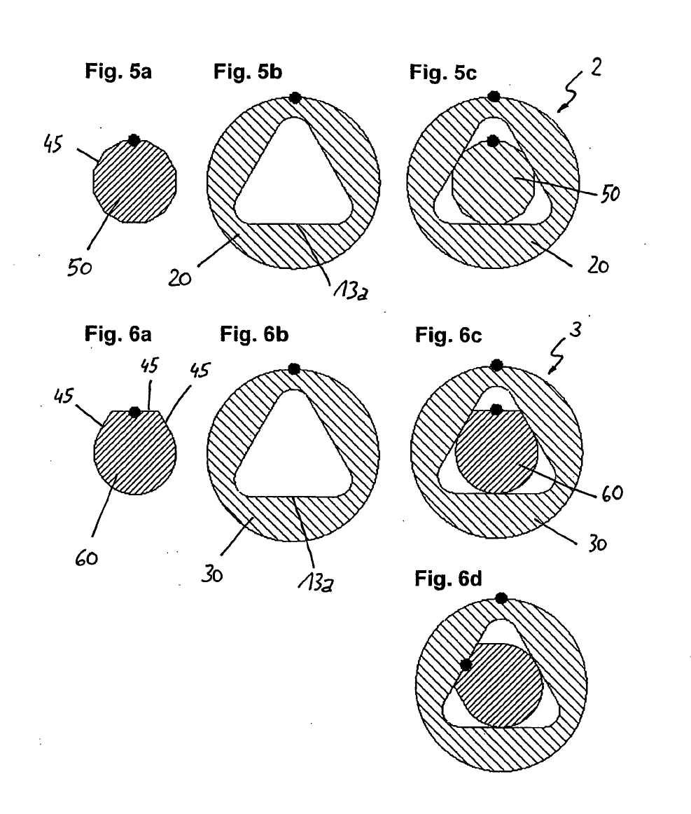

With reference to FIG. 5, a further embodiment of the tooth replacement system 2 according to the invention will be discussed in which, in the assembled state, an abutment 50 is blocked securely against twisting in the implant 20 by the form-fit interaction of a wrench socket 13a, having a cross section substantially in the shape of an equilateral triangle in the implant 20, and of an external polygon 44, designed with twelve edges on the abutment 50.

According to a further embodiment of the tooth replacement system 3 according to the invention, not all locking surfaces are physically embodied in an abutment to be inserted, and instead only a minimum required number of active surfaces is formed. FIG. 6a shows schematically how in an abutment 60, which has a substantially circular cross section in the area of the locking means, three active surfaces arranged tangentially with respect to the cylindrical jacket surface form a two-edge structure. This two-edge structure, with its three locking surfaces 45, corresponds functionally to a regular hexagon and permits rotationally locked insertion of the abutment 60 in six predefined angle positions. In FIGS. 6c and 6d, two angle positions of the abutment 60 are indicated by means of a dot, while a further dot indicates the fixed arrangement of the implant 30.

It will be clear, particularly from the above-described embodiment of the tooth replacement system 3 according to the invention, that the term “polygon” used here includes not just “genuine polygons” in the form of polygonal prisms with regular polygonal cross-sectional surfaces and uniform side widths, but also “functional polygons” in which irregular polygonal prisms have sufficient areas of the genuine polygon to be able to serve as means with the same action.

With reference to FIGS. 7a to 7c, another advantageous embodiment of the tooth replacement system 4 according to the invention will be discussed in which an inserted abutment 70 is blocked securely against twisting in the implant 31 by the form-fit interaction of a wrench socket 13a, having a cross section substantially in the shape of a square in the implant 31, and of an external polygon 44, designed as an external hexagon on the abutment 70.

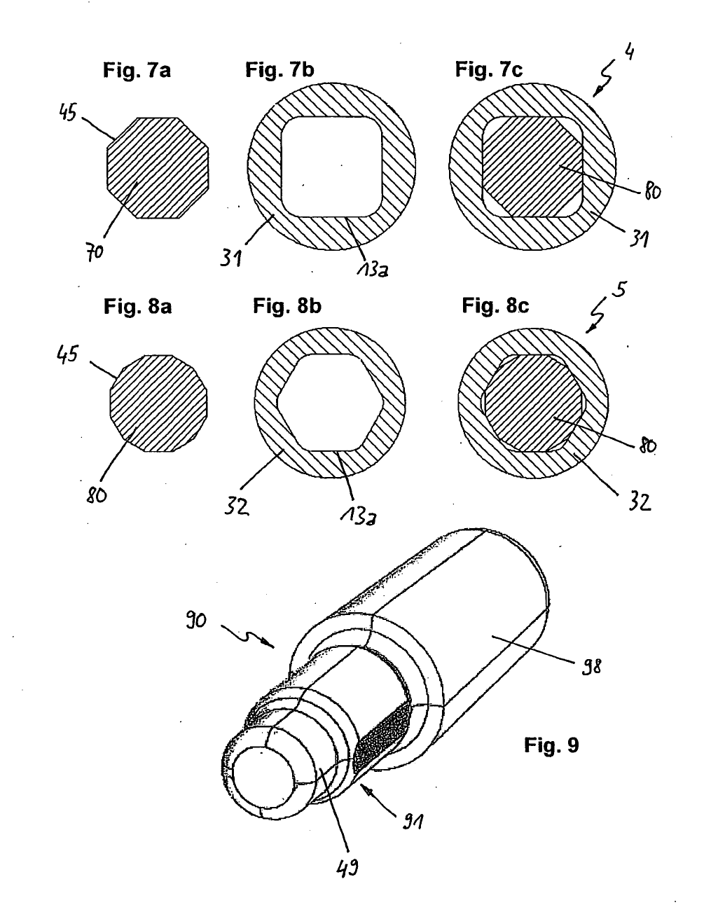

As an example of other pairs of locking means based on regular polygons, a further embodiment of a tooth replacement system 5 according to the invention based on the six series is shown in FIGS. 8a to 8c. In the assembled state, therefore, an abutment 80 is blocked securely against twisting in the implant 32 by the form-fit interaction of a wrench socket 13a, having a cross section substantially in the shape of a hexagon socket in the implant 32, and of an external polygon 44, designed with twelve edges on the abutment 80.

It should be noted that abutments that are not locked against rotation can also be inserted into an implant 10, 20, 30, 31, 32 according to the present invention, for example like the abutment 90 shown in FIG. 9. The implants 10, 20, 30, 31, 32 in this case enclose a circular cylindrical proximal portion 49 of an abutment stem 91 of the abutment 90, such that the abutment 90, in the fully inserted state, is freely rotatable in the proximal internal polygon or polygonal wrench socket 13, 13a of the implant 10, 20, 30, 31, 32.

The tooth replacement systems according to the invention can preferably be positioned in at least six radial angle positions. The polygonal locking means 13, 13a in the proximal area of the receiving openings of the implants serve, on the one hand, as aids for the radial positioning and rotationally locked mounting of the abutment in the implant and, on the other hand, for receiving the screwing tool in a torque-positive manner when the implant is being screwed in. The location directly above the solid, externally threaded proximal part of the implant permits optimal force transmission, with minimal torsional loading of thin-walled implant areas during insertion into the jaw bone, and is therefore particularly suitable for production from ceramic materials.

From the present disclosure, it will be readily apparent to a person skilled in the art that the tooth replacement systems 1, 2, 3, 4, 5 according to the invention permit maximum freedom of choice of material. The implants and also the abutments can be made from titanium or ceramic, and both structural parts can be used in all possible material combinations. This permits for the first time the insertion or adhesive bonding of ceramic abutments into implants made from titanium oxide or other metallic materials.

The advantages, however, are most evident in the production of implants and abutments made from ceramics. Ceramic production materials that have proven particularly useful are known zirconium oxide or zirconium oxide/aluminium mixtures.

Although only axially symmetrical abutments are depicted in the illustrative embodiments, the teaching according to the invention can also be applied to abutments having a head that is angled with respect to the stem. The same is true of the slightly conical shape of the abutment head, which can easily also be designed, preferably in the case of ceramic abutments, as a cylinder for individual reshaping.

In contrast to previously known abutments that are screwed into the implant, the connection according to the invention between implant and abutment avoids the risk of stresses occurring in the system and/or of screw fractures being caused by overloading.

### List of Reference Numbers

| | |
|---|---|
| tooth replacement system | 1, 2, 3, 4, 5 |
| annular gap | 9 |
| implant | 10, 20, 30, 31, 32 |
| receiving opening | 11 |
| coronal end | 12 |
| internal triangle | 13 |
| polygonal wrench socket | 13a |
| close-fit seat | 14 |
| bottom | 15 |
| annular surface | 16 |
| abutment | 40, 50, 60, 70, 80, 90 |
| abutment stem | 41, 91 |
| close-fit cylinder | 42 |
| narrowing | 43 |
| external polygon | 44 |
| locking surface | 45 |
| base surface | 46 |
| flange | 47 |
| head area | 48 |
| proximal portion | 49 |

1. A tooth replacement system comprising an implant for osseointegration in a jaw bone, and an abutment, wherein the abutment can be positioned in at least two radial angle positions by form-fit interaction of a locking means, on a proximal abutment base, and of at least one inner wall of a proximal portion of a receiving opening.

2. A tooth replacement system according to claim 1, wherein the locking means comprise an N-edge wrench socket in the implant and an N*X external polygon on the abutment, where N designates the number of locking surfaces in the wrench socket and N*X stands for an integral multiple of N.

3. A tooth replacement system according to claim 1, wherein pairs of locking means are based on regular polygons.

4. A tooth replacement system according to claim 1, wherein the regular polygons are polygonal prisms with regular polygonal cross-sectional surfaces and uniform side widths.

5. A tooth replacement system according to claim 1, pairs of locking means are based on a regular N-edge wrench socket in the implant and on a functional N*X external polygon on the abutment, in which only a minimum necessary number of active surfaces are physically embodied as functional locking surfaces.

6. A tooth replacement system according to claim 1, wherein pairs of locking means are based on a regular N*X external polygon on the abutment and on a functional N-edge wrench socket in the implant, in which only at least one active surface or a minimum necessary number of active surfaces are physically embodied as functional locking surfaces and are formed as an internal socket in the area of the proximal abutment base and of at least one inner wall of a proximal portion of the receiving opening in the implant.

7. A tooth replacement system according to claim 1, wherein the abutment can be adhesively bonded in the receiving opening.

8. A tooth replacement system according to claim 1, wherein the implant and/or abutment are made from titanium or ceramic.

9. A tooth replacement system according to claim 1, wherein the implant and/or the ceramic abutment are made from zirconium oxide or a zirconium oxide/aluminum mixture.

10. A tooth replacement system according to claim 1, wherein, when the abutment is inserted, the abutment stem lies with a base surface on a bottom surface in the receiving opening.

11. A tooth replacement system according to claim 1, wherein the abutment is designed as a solid body.

12. A tooth replacement system according to claim 3, wherein each pair of locking means are based on regular polygons selected from a three, four, five or six series.
